(19) United States
(12) Patent Application Publication
(10) Pub. No.: US 2002/0167716 A1
(43) Pub. Date: Nov. 14, 2002

(54) Optical amplifier and optical transmission system

(75) Inventor: Koji Yamanaka, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THE FURUKAWA ELECTRIC CO., LTD., Tokyo (JP)

(21) Appl. No.: 10/011,980

(22) Filed: Dec. 11, 2001

(30) Foreign Application Priority Data
May 14, 2001 (JP) 2001-143736

(51) Int. Cl. H01S 3/00

(52) U.S. Cl. 359/334

(57) ABSTRACT

The optical amplifier obtains signal light power and a multiple wavelength number of a signal light received from a pre-stage EDFA, and determines a gain of Raman amplification such that the power of this signal light becomes optimum input power to a next-stage EDFA. The optical amplifier controls an HPU (High Power Unit) according to the determined gain, and Raman amplifies the input signal light.

### FIELD OF THE INVENTION

The present invention relates to an optical amplifier and an optical transmission system capable of compensating for a signal light having a distortion generated in an EDFA, with a Raman amplifier to obtain optimum input power in the EDFA, and realizing a long-distance transmission with more stable and higher reliability.

### BACKGROUND OF THE INVENTION

Along a rapid distribution of the Internet and a rapid increase in connections between LANs within enterprises in recent years, there has been a trend of a large capacity in the transmitted contents data like dynamic images, not only the increase in the number of communication calls. Consequently, this has generated a problem of a rapid increase in data traffics. Under this situation, a WDM (wavelength division multiplex) system has been developed remarkably and has also be distributed, in order to prevent a reduction in the communication performance due to the increase in the data traffics.

The WDM system realizes a large-capacity transmission of information that is a hundred times a conventional transmission capacity, with one fiber by allocating a plurality of optical signals to waves of mutually different wavelengths. Particularly, the existing WDM system uses an erbium-doped fiber amplifier (hereinafter to be referred to as an EDFA) to achieve a wide-band and long-distance transmission. The EDFA is an amplifier that utilizes the following principle. Namely, when a pumping laser of a wavelength 1480 nm or a wavelength 980 nm is used to transmit a light through a special optical fiber added with an element called erbium, a light of a wavelength 1550 nm band as a transmission signal is amplified in this special fiber.

FIG. 6 is a block diagram showing a schematic structure of a conventional WDM system. As shown in FIG. 6, according to the conventional WDM system, an EDFA (100, 110) is provided at every predetermined interval on a transmission line 99 that uses an optical fiber as a transmission medium. A signal light that is transmitted through the transmission line 99 is amplified by these plurality of EDFA's. With this arrangement, the signal light maintains minimum power that is recognized as information.

Each EDFA (100, 110) is usually structured by an erbium-doped fiber, a pumping laser for pumping this erbium-doped fiber, an optical isolator, and an optical filter (not shown).

In each EDFA (100, 110) for carrying out the above wavelength division multiplexing, it is necessary to have a flat gain profile along the wavelength range that structures the signal light, in order to avoid occurrence of different amplification degrees between the wavelengths. In other words, it is desirable that each EDFA (100, 110) minimizes a gain deviation from the wavelength range of the signal light.

Therefore, usually, it is most general that each EDFA (100, 110) has a gain equalization filter or the like to optimize the gain specifications so that a most flat gain profile is shown to the signal light having predetermined signal light power. FIG. 7 is a diagram for explaining a gain profile in the conventional EDFA. FIG. 7 shows an example of gain profiles of a case where signal light power is −17 dBm and a case where signal light power is −25 dBm respectively. Particularly, in this EDFA, when the signal light power of −17 dBm has been input, the gain profile is adjusted so as to be able to obtain a most uniform gain over the range of wavelengths from 1540 nm to 1580 nm. On the other hand, when the signal light power of −25 dBm has been input, there is a large gain deviation at a short wavelength side as compared with the case where the signal light power of −17 dBm has been input. As a result, it is not possible to obtain a uniform gain in this case.

Accordingly, in the WDM system using EDFA's, it is desirable to design the WDM system such that the power of a signal light that is input to the EDFA's provides a most flat gain profile of the EDFA's.

### SUMMARY OF THE INVENTION

It is an object of the present invention to provide an optical amplifier and an optical transmission system capable of compensating for a signal light having a distortion generated in an EDFA, with a Raman amplifier to obtain optimum input power in the EDFA, and realizing a long-distance transmission with more stable and higher reliability.

The optical amplifier according to one aspect of the present invention receives a signal light amplified by a lumped optical amplifier, and Raman amplifies the signal light such that the signal light produces predetermined signal light power that is optimum in the lumped optical amplifier.

The optical amplifier according to another aspect of the present invention receives a signal light amplified by a lumped optical amplifier, determines input signal light power that becomes optimum in the lumped optical amplifier, based on a multiple wavelength number and a signal light power value of the signal light, and Raman amplifies the signal light such that the signal light produces the input signal light power.

The optical amplifier according to still another aspect of the present invention comprises, an optical demultiplexer unit which branches a signal light that has been amplified and transmitted to a transmission line by a lumped optical amplifier, a monitoring unit which detects signal light power of a signal light branched by the optical demultiplexer unit, a determination unit which compares signal light power detected by the monitoring unit with optimum input signal light power of the lumped optical amplifier stored in advance, and determining a gain necessary for Raman amplifying the signal light to obtain the optimum input signal light power of the signal light, based on a result of the comparison, and a pumping light source for outputting a pumping light of a power corresponding to a gain determined by the determination unit, to the transmission line.

The optical transmission system according to still another aspect of the present invention comprises, a plurality of lumped optical amplifiers on a transmission line, and an optical amplifier disposed on the transmission line between the lumped optical amplifiers, wherein the optical amplifier receives a signal light amplified by a pre-stage lumped optical amplifier, and Raman amplifies the signal light such that the signal light produces predetermined signal light power that becomes optimum in a post-stage lumped optical amplifier.

The optical transmission system according to still another aspect of the present invention comprises a plurality of lumped optical amplifiers on a transmission line. The optical transmission system further comprises, a signal light information transmitter for transmitting at least a control signal light showing a multiple wavelength number of a signal light propagated on the transmission line, to the transmission line, a signal light information receiver for receiving the control signal light, and an optical amplifier disposed on the transmission line between the lumped optical amplifiers, for inputting a signal light amplified by a pre-stage lumped optical amplifier, obtaining a signal light power value of the input signal light from this input signal light, obtaining a multiple wavelength number of the signal light from the signal light information receiver, determining input signal light power that is optimum in a post-stage lumped optical amplifier, based on the signal light power value and the multiple wavelength value obtained, and Raman amplifying the signal light such that the signal light produces the input signal light power.

Other objects and features of this invention will become apparent from the following description with reference to the accompanying drawings.

### BRIEF DESCRIPTION OF THE DRAWINGS

FIG. 1 is a block diagram showing a schematic structure of an optical amplifier and an optical transmission system using the optical amplifier according to an embodiment of the present invention;

FIG. 2 is a diagram showing a structure example of an HPU (High Power Unit) of the optical amplifier according to the embodiment of the invention;

FIG. 3 is a flowchart for explaining the operation of the optical amplifier and the optical transmission system according to the embodiment of the invention;

FIG. 4 is a diagram showing an example of an “EDFA optimum input power table” stored in the optical amplifier and the optical transmission system according to the embodiment of the invention;

FIG. 5 is a diagram showing an example of a “pumping light power table” stored in the optical amplifier and the optical transmission system according to the embodiment of the invention;

FIG. 6 is a block diagram showing a schematic structure of a conventional WDM system;

FIG. 7 is a diagram for explaining a gain profile in a conventional EDFA system;

FIG. 8A and FIG. 8B are diagrams for explaining problems of the conventional WDM system.

### DETAILED DESCRIPTION

The present invention has been achieved in order to solve the following problems. In the case of a super-long distance WDM system that has more than a hundred relay points, there has been a problem that even if a gain deviation in an EDFA is minute, this is accumulated at each relay point, and this consequently narrows the gain band.

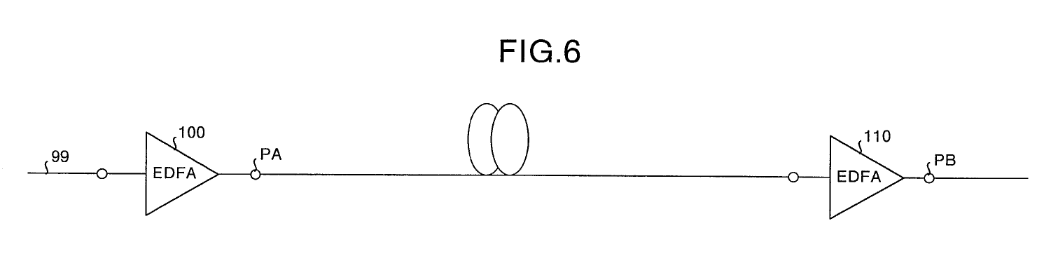

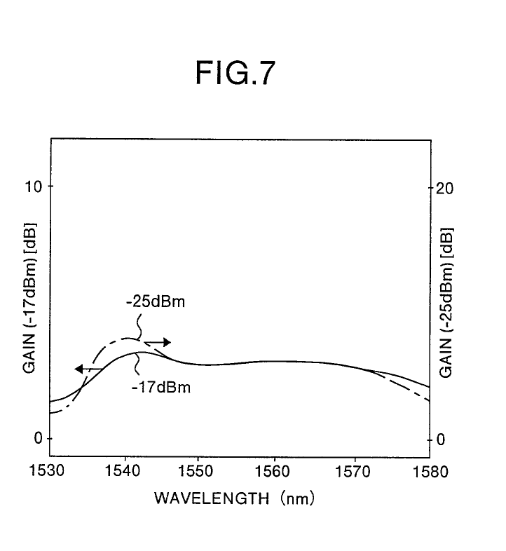

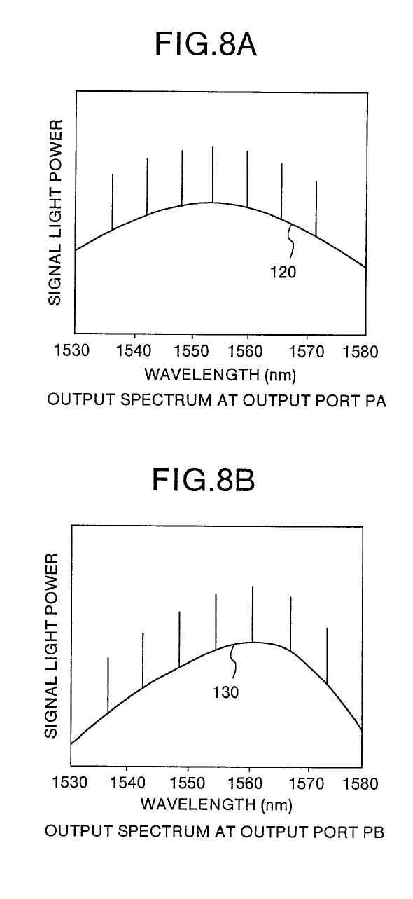

FIG. 8A and FIG. 8B are diagrams for explaining the above problem. FIG. 8A shows an output spectrum at an output port PA of the first-stage EDFA 100 shown in FIG. 6, and FIG. 8B shows an output spectrum at an output port PB of the next-stage EDFA 110 shown in FIG. 6. As shown in FIG. 8A and FIG. 8B, a signal light having the same information at a first EDFA is output as a signal having a different signal light power distribution at the next EDFA. This is not only because the signal light power has not been amplified completely flat over the multiple wavelengths due to the fine gain deviation. This is also because the signal light has been deviated from the optimum power due to the gain deviation, and it is not possible to obtain amplification based on a flat gain profile at the next-stage EDFA.

Particularly, in the EDFA, it is not possible to avoid the occurrence of ASE (Amplified Spontaneous Emission) noise. Thus, the signal light spectrum is subjected to the amplification of the same gain profile together with an ASE component 120, as shown in FIG. 8A. Accordingly, an ASE component 130 is also subjected to the influence of a gain deviation, as shown in FIG. 8B.

In the mean time, the EDFA is a lumped optical amplifier in which portions for pumping an optical signal are concentrated. Therefore, there has been a limit to this EDFA in that there is a loss of a transmission path optical fiber leading to the accumulation of noise, and the EDFA is subjected to non-linearity that becomes the cause of signal distortion and noise. Further, the EDFA makes it possible to carry out optical amplification in a band that is determined by band gap energy of erbium, and it has been difficult to obtain a wide band for realizing further multiplexing.

As an optical amplifier that replaces the EDFA, attention has been paid to a Raman amplifier. The Raman amplifier is a distribution-type optical amplifier that uses a normal transmission line fiber as a gain medium, without requiring a special fiber like an erbium-doped fiber that is used in the EDFA. Therefore, as compared with the WDM transmission system that is based on the conventional EDFA, the Raman amplifier can improve the transmission quality.

Particularly, according to the recent researches, it has been made clear that it is possible to build up an optimum system when a Raman amplifier is used together with an EDFA, instead of using the Raman amplifier as a single unit. It is expected to be able to improve the transmission capacity of this system to a few times to ten or more times the transmission capacity of a system that uses only EDFA's. However, the WDM system using this Raman amplifier has not yet been established, and it is still at a stage of a detailed investigation for utilization.

An embodiment of an optical amplifier and an optical transmission system according to the present invention will be explained in detail below with reference to the drawings. It should be noted that this embodiment does not limit the present invention.

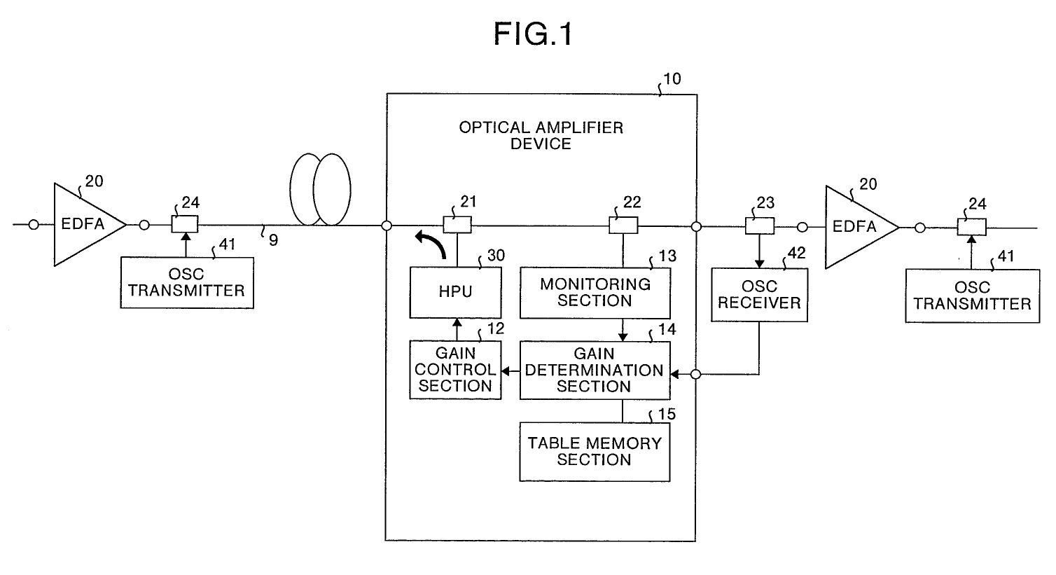

FIG. 1 is a block diagram showing a schematic structure of an optical amplifier and an optical transmission system using the optical amplifier according to the embodiment of the present invention. In FIG. 1, the optical transmission system is composed of an EDFA 20 for amplifying a signal light on a transmission line 9, an OSC (Optical Supervisory Channel) transmitter 41 for transmitting an SV signal like control information, an optical multiplexer 24 for transmitting an SV signal output from the OSC transmitter 41 to the transmission line 9, an optical amplifier 10 for carrying out a distribution-type optical amplification based on Raman amplification, an OSC receiver 42 for receiving the SV signal, and an optical optical demultiplexer unit 23 for guiding an SV signal on the transmission line 9 to the OSC receiver 42.

This optical transmission system is a WDM system. The OSC transmitter 41 transmits at least a number of channels of signal lights propagated on the transmission line 9, that is, information showing a wavelength number, by including this information in the SV signal.

Further, the optical amplifier 10 is composed of an optical multiplexer 21, an optical demultiplexer unit 22, a gain control section 12, a monitoring section 13, a gain determination section 14, a table memory section 15, and an HPU 30. The monitoring section 13 is a unit which receives a signal light branched by the optical demultiplexer unit 22, and detecting signal light power of this signal light. This monitoring section 13 consists of a light-receiving element like a photodiode. The gain determination section 14 is a unit which determines a gain control parameter specified by an “EDFA optimum input power table” and a “pumping light power table” stored in the table memory section 15, based on the signal light power detected by the monitoring section 13.

The gain control section 12 is a unit which controls an oscillation output of each laser unit of the HPU 30 according to a gain control parameter determined by the gain determination section 14. This gain control section 12 consists of an APC (automatic output control circuit) or the like. The HPU 30 is a unit which outputs a pumping light of a gain according to the control of the gain control section 12.

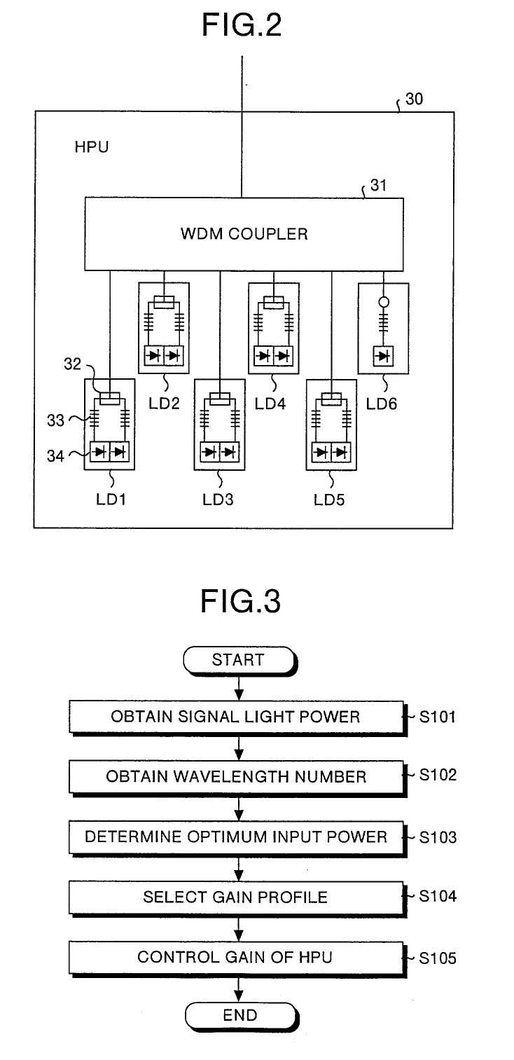

FIG. 2 is a diagram showing a structure example of the HPU 30. In FIG. 2, the HPU 30 is composed of six laser units LD1 to LD6 having different oscillation center wavelengths, and a Machtzender-type WDM coupler 31. Each of the laser units LD1 to LD6 has two Fabry-Perot type semiconductor lasers 34 having the same oscillation center wavelength. Each laser unit wavelength stabilizes a laser output of each semiconductor laser 34 with a fiber brag grating (FBG) 33. A polarization multiplexer (PBC) 32 multiplexes these laser outputs and produces one output. The polarization multiplexing by the PBC 32 is a measure for increasing the pumping power of each oscillation center wavelength, and for reducing the polarization dependency of Raman gain.

Laser outputs obtained from the laser units LD1 to LD6 are multiplexed by the WDM coupler 31, and a high-output multiplexed pumping light is output. The pumping light output from the HPU 30 is transmitted through an optical fiber of the transmission line 9 via the optical multiplexer 21. FIG. 1 shows an example of a backward pumping. A pumping light multiplexed by the optical multiplexer 21 is transmitted through the transmission line 9 to a direction opposite to the proceeding direction of the signal light.

When the high-output pumping light is transmitted through the transmission line 9, a Raman scattered light shifted to a long wavelength side by 110 nm from the pumping light is generated, based on material characteristics of the optical fiber of the transmission medium. Then, through an induction Raman scatter process, the energy of the pumping light is shifted to the signal light. Based on this, the signal light is amplified.

Next, the operation of the optical amplifier and the optical transmission system according to the embodiment will be explained. FIG. 3 is a flowchart for explaining the operation of the optical amplifier and the optical transmission system according to the embodiment of the invention. First, the optical amplifier 10 detects a signal light propagating through the transmission line 9, with the monitoring section 13, and obtains a value of this signal light power (step S101). Then, the value of this signal light power obtained by the monitoring section 13 is input to the gain determination section 14.

In the mean time, the OSC receiver 42 receives an SV signal transmitted from the OSC transmitter 41, and obtains a wavelength number from the received SV signal (step S102) The obtained wavelength number is input to the gain determination section 14. When the gain determination section 14 has obtained the value showing the signal light power and the wavelength number, the gain determination section 14 determines optimum input power by referring to the “EDFA optimum input power table” stored in advance in the table memory section 15 (step S103).

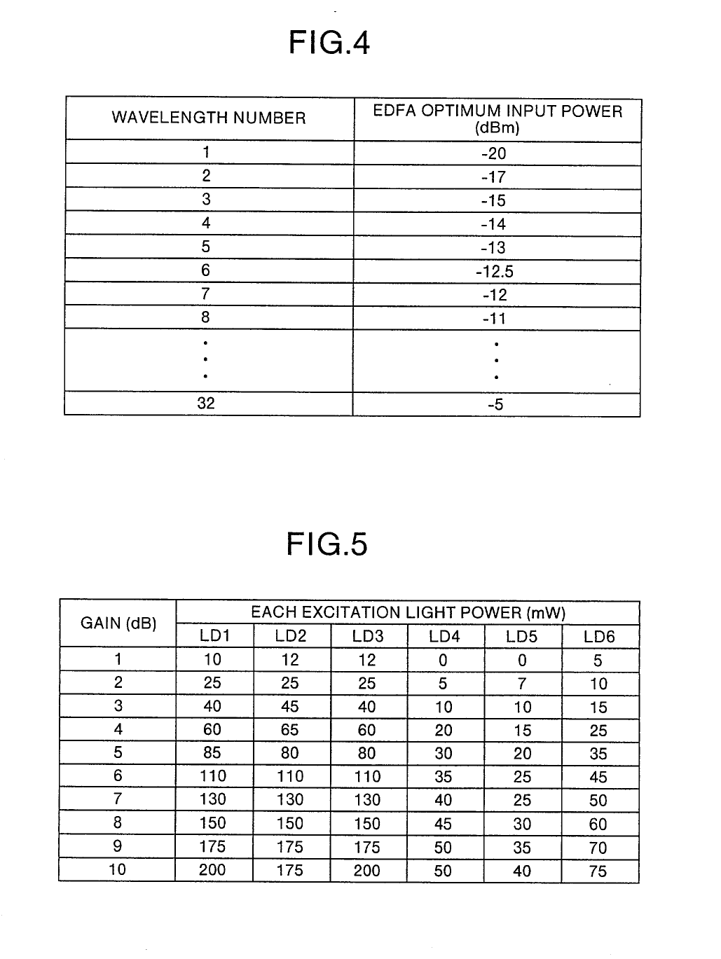

FIG. 4 is a diagram showing an example of the “EDFA optimum input power table”. As shown in FIG. 4, the “EDFA optimum input power table” is a table that shows an optimum input power value in the EDFA 20 for each multiplexed wavelength number. In this case, the optimum input power means the power that shows a most flat gain to the wavelength number, as explained in “Description of the Related Art”. For example, in FIG. 4, when the obtained wavelength number is 2, this the unit that the EDFA 20 can amplify the input signal light with a flat gain most efficiently when the input signal light has the power of −17 dBm. The gain determination section 14 determines this −17 dBm as the most optimum input power.

Next, the gain determination section 14 compares the obtained signal light power with the optimum input power determined at the above step S103, and calculates a difference between the two. The gain determination section 14 further calculates a gain necessary for the obtained signal light power to become the optimum input power, based on a result of the calculation. The gain determination section 14 selects pumping light power (a gain profile) that is necessary for each laser unit that constitutes the HPU 30, by referring to the “pumping light power table” stored in advance in the table memory section 15 (step S104).

FIG. 5 is a diagram showing an example of the “pumping light power table”. As shown in FIG. 5, the “pumping light power table” is a table that shows values of pumping power of the laser units that constitute the HPU 30 for each necessary gain. For example, when a necessary gain is 3 dB as a result of the above calculation, in FIG. 5, a gain profile of pumping light power 40 mW, 45 mW, 40 mW, 10 mW, 10 mW, and 15 mW is selected for the laser units LD1 to LD6 respectively.

When the gain determination section 14 has selected a gain profile in the manner as described above, the gain determination section 14 inputs a control signal of each pumping light power shown in the gain profile to the gain control section 12. The gain control section 12 changes the gain of the laser units LD1 to LD6 within the HPU 30 according to the input control signal (step S105).

When the HPU 30 has already received the gain control based on the “pumping light power table” in the above process, the gain determination section 14 selects a gain profile from a result of the addition of a new necessary gain to a previously necessary gain. For example, when the gain determination section 14 has calculated a necessary gain as 2 based on a result of the monitoring section 13 and the calculations by the gain determination section 14 in a status that the HPU 30 has already received a gain control based on the gain profile corresponding to the gain 3, a gain profile corresponding to the gain 5, that is the gain 2 of this time added to the gain 3 of the last time, is selected.

As explained above, in the optical amplifier according to the present embodiment, a signal light that propagates through the transmission line 9 is Raman amplified so that the power of the signal light becomes optimum input power of the EDFA 20. Therefore, it is possible to input a signal light that is always optimum power to the next-stage EDFA Furthermore, based on a provision of the above optical amplifier between the EDFA's, it is always possible to carry out optimum amplification in a flat gain profile over multiple wavelengths in the next-stage EDFA 20. As a result, it is possible to prevent conventional superimposition of gain deviations along the increase in the number of relay stages, and it is possible to further increase a long transmission distance.

In the above embodiment, the optical amplifier according to the present invention is provided in an optical transmission system that uses EDFA's, in order to compensate for signal light power. It is also possible to similarly apply the invention to an optical transmission system that is built up with a lumped optical amplifier like semiconductor laser amplifiers other than EDFA's.

FIG. 1 shows an example of a case where the optical amplifier carries out a backward pumping. It is also possible to realize a similar structure to obtain similar effects when a system has a combination of a forward pumping or a backward pumping with a forward pumping, based on a provision of the monitoring section 13, the gain determination section 14, the table memory section 15, and the gain control section 12.

Further, although the WDM system using EDFA's is usually provided with the OSC transmitter 41 and the OSC receiver 42 described above, it is also possible to add a structure of the OSC receiver 42 and the optical multiplexer 23 to the structure of the optical amplifier 10 according to the present invention.

As explained above, in the optical amplifier according to the present invention, the optical amplifier performs Raman amplification to a signal light that propagates through a transmission line such that this signal light gives optimum power to a lumped optical amplifier like an EDFA. Therefore, it is always possible to input a signal light of optimum power that shows a flat gain profile over multiple wavelengths with high amplification efficiency, to a next-stage lumped optical amplifier. As a result, there is an effect that it is possible to practically reduce the superimposition of gain deviations.

Further, in the optical transmission system according to the present invention, the above-described optical amplifier is provided between lumped optical amplifiers, in the optical transmission system that is built up with lumped optical amplifiers like conventional EDFA's. With this arrangement, it is always possible to carry out optimum amplification with a flat gain profile over multiple wavelengths at a next-stage lumped optical amplifier. As a result, it is possible to prevent the superimposition of gain deviations along the increase in the number of relay stages, unlike the conventional practice. Further, it becomes possible to increase the signal light transmission distance to a longer distance, based on a double gain with the lumped optical amplifiers and the distribution-type optical amplifiers.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An optical amplifier, wherein the optical amplifier receives a signal light amplified by a lumped optical amplifier, and Raman amplifies the signal light such that the signal light produces predetermined input signal light power that is optimum in the lumped optical amplifier.

2. An optical amplifier, wherein the optical amplifier receives a signal light amplified by a lumped optical amplifier, determines an input signal light power that becomes optimum in the lumped optical amplifier, based on a multiple wavelength number and a signal light power value of the signal light, and Raman amplifies the signal light such that the signal light produces the input signal light power.

3. An optical amplifier comprising:
an optical demultiplexer unit which branches a signal light that has been amplified and transmitted to a transmission line by a lumped optical amplifier;
a monitoring unit which detects signal light power of a signal light branched by the optical demultiplexer unit;
a determination unit which compares signal light power detected by the monitoring unit with optimum input signal light power of the lumped optical amplifier stored in advance, and determines a gain necessary for Raman amplifying the signal light to obtain the optimum input signal light power of the signal light, based on a result of the comparison; and
a pumping light source which outputs a pumping light of a power corresponding to a gain determined by the determination unit, to the transmission line.

4. The optical amplifier according to claim 3, wherein
the determination unit selects one of a plurality of sets of optimum input signal light power of a lumped optical amplifier stored in advance as the optimum input signal light power to be compared, based on a multiple wavelength number of the signal light.

5. An optical transmission system comprising:
a plurality of lumped optical amplifiers arranged on a transmission line; and
an optical amplifier disposed on the transmission line between the lumped optical amplifiers, wherein the optical amplifier receives a signal light amplified by a pre-stage lumped optical amplifier, and Raman amplifies the signal light such that the signal light produces predetermined signal light power that becomes optimum in a post-stage lumped optical amplifier.

6. The optical transmission system according to claim 5, wherein the lumped optical amplifiers are erbium-doped fiber amplifiers.

7. An optical transmission system comprising:
a plurality of lumped optical amplifiers arranged on a transmission line; and
a signal light information transmitter which transmits at least a control signal light showing a multiple wavelength number of a signal light propagated on the transmission line, to the transmission line;
a signal light information receiver which receives the control signal light; and
an optical amplifier disposed on the transmission line between the lumped optical amplifiers, wherein the optical amplifier receives a signal light amplified by a pre-stage lumped optical amplifier, obtains a signal light power of the signal light, obtains a multiple wavelength number of the signal light from the signal light information receiver, determines an input signal light power that is optimum in a post-stage lumped optical amplifier, based on the obtained signal light power and the multiple wavelength number, and Raman amplifies the signal light such that the signal light produces the input signal light power.

8. The optical transmission system according to claim 7, wherein the lumped optical amplifiers are erbium-doped fiber amplifiers.

9. The optical transmission system according to claim 7, wherein
the signal light information transmitter is an Optical Supervisory Channel transmitter, and
the signal light information receiver is an Optical Supervisory Channel receiver.

10. The optical transmission system according to claim 9, wherein the lumped optical amplifiers are erbium-doped fiber amplifiers.
